(19) United States
(12) Patent Application Publication
(10) Pub. No.: US 2017/0126173 A1
(43) Pub. Date: May 4, 2017

(54) APPARATUS AND METHOD OF LIGHT GUIDING WITH ELECTRICITY GENERATING

(71) Applicant: Industrial Technology Research Institute, Hsinchu (TW)

(72) Inventors: Tien-Fu Huang, Hsinchu County (TW); Shih-Hao Hua, Changhua County (TW); Wei-Chi Lai, Taichung City (TW); Chao-Pin Chen, Changhua County (TW)

(21) Appl. No.: 14/963,249

(22) Filed: Dec. 9, 2015

(30) Foreign Application Priority Data
Oct. 30, 2015 (TW) 104135770

(51) Int. Cl. H02S 40/22; G02B 19/00; G02B 26/08

(52) U.S. Cl. CPC H02S 40/22; G02B 26/0816; G02B 19/0023; G02B 19/0042

(57) ABSTRACT

A light guiding apparatus includes at least adjacent two light-receiving devices having a first light-receiving device and a second light-receiving device. Each light-receiving device has an illuminated surface and a shady surface according to a position of incident light. A holding member is respectively disposed over the corresponding first light-receiving device. A light guiding device is disposed on the holding member. The light guiding device has a curved reflection surface and a rotating mechanism. The rotating mechanism is used to guide the incident light onto a shady surface of the second light-receiving device or shield the first light-receiving device. A driving control apparatus controls the rotating mechanism for rotating the light guiding device.

### CROSS REFERENCE TO RELATED APPLICATIONS

This application claims the priority benefit of Taiwan application serial no. 104135770, filed on Oct. 30, 2015. The entirety of the above-mentioned patent application is hereby incorporated by reference herein and made a part of this specification.

### TECHNICAL FIELD

The disclosure relates to a light guiding apparatus, and particularly relates to a light guiding and electricity generating technology.

### BACKGROUND

Solar energy is a kind of natural energy. In the trend of development of the green industry, the use of solar energy must be taken into consideration. For example, the use of the solar energy in greenhouse is now under development.

Taking the use of solar energy in greenhouse as an example, the conventional greenhouse systems may be categorized into enclosed type and semi-open type greenhouse systems. The enclosed type greenhouse system adopts a shelf-type vertical three-dimensional planting structure, along with total artificial light sources (e.g., fluorescent or light emitting diode (LED) lamps) and air-conditioning systems to control the environment. Thus, planting using the enclosed type greenhouse system consumes a significant amount of energy. The semi-open type greenhouse system mainly uses solar energy instead, with supplemental lighting from artificial light sources. The greenhouse is used to control the environment (e.g., shielding the light, ensuring ventilation, and reducing the temperature, etc.,), and consumes significantly less energy than the enclosed type greenhouse system.

Recently, the semi-open greenhouse has adopted vertical three-dimensional trellis, instead of single-layer planar structure, to increase the yield per unit area. However, as the sun moves through the daytime and seasons, the issue of uneven light shielding and reception may arise in the middle or lower layer in a stacked multi-layer vertical structure. If the artificial light sources are used to provide supplemental lighting, as in the enclosed type greenhouses, a significant amount of energy will also be consumed. Therefore, there is a tendency in three-dimensional planting that an A-shaped three-dimensional planting structure is used to replace the vertical type planting structure, so as to improve on the overuse of artificial light sources in the vertical three-dimensional planting structure. However, as the illumination angle of the sun changes through the daytime, there may be an illuminated surface and a shady surface. Namely, the illuminated surface in the morning may be the shady surface in the afternoon. Thus, such structure may result in lack of illumination in the shady surface and uneven light reception, and the quality of crops may thus be affected.

In a light-receiving system using the conventional A-shaped three-dimensional planting structure, when an A-shaped three-dimensional planting trellis is disposed in a direction parallel with lines of longitude, the crops are arranged in a direction perpendicular to the lines of longitude. Since the sun rises from the east and sets in the west, the A-shaped planting trellis may have an illuminated surface and a shady surface with respect to sunlight. For example, in the afternoon, the sunlight illuminates from the southwest, and the surface of the trellis facing toward the west is the irradiated surface, and the surface facing toward the east is the shady surface. The illuminated surface that receives the sunlight has a greater effective area, and the amount of illumination received by the higher and lower layers is more even. However, when the illuminated surface receives the sunlight, the shady surface is in the shade and unable to effectively receive the sunlight. Besides, the sunlight directly illuminates the trellis, so the crops in the trellis may be overly illuminated.

Thus, how to make a better use of solar energy with the trellis is an issue that requires further design and development.

### SUMMARY

The disclosure provides a light guiding and electricity generating apparatus and method that allow a light-receiving device to receive incident light, such as sunlight, in a more effective way, and generate electricity at the same time.

An embodiment of the disclosure provides a light guiding apparatus, including at least two adjacent light-receiving devices. The at least two adjacent light-receiving devices include a first light-receiving device and a second light-receiving device. In addition, each of the light-receiving devices has an illuminated surface and a shady surface according to a position of incident light. The light guiding apparatus also includes a holding member disposed over the corresponding first light-receiving device. The light guiding apparatus further includes a light guiding device disposed on the holding member and located above the first light-receiving device. In addition, the light guiding device has a curved reflection surface and a rotating mechanism and reflects the incident light for guiding toward the shady surface of the adjacent second light-receiving device or shield the first light-receiving device by using the rotating mechanism. Furthermore, the light guiding apparatus includes a driving control apparatus controlling the rotating mechanism to rotate the light guiding device.

An embodiment of the disclosure provides a light guiding and electricity generating method. The method includes disposing a light guiding and electricity generating device above a first light-receiving device; controlling the rotating mechanism by using a driving control apparatus, so as to reflect incident light for guiding to a shady surface of a second light-receiving device adjacent to the first light-receiving device by using the curved reflection surface; and controlling the rotating mechanism by using the driving control apparatus to make the solar cell receive the incident light and shield the first light-receiving device. The light guiding and electricity generating device has a curved reflection surface and a solar cell opposite to the curved reflection surface, and the light guiding and electricity generating device has a rotating mechanism.

Based on above, in the light guiding and electricity generating apparatus and method according to the embodiments of the disclosure, the incident light may be guided to illuminate the shady surface of the light-receiving device by controlling of the rotation, so as to increase the amount of illumination of the shady surface and maintain the evenness of illumination, thereby allowing crops to have a better quality by increasing illumination to the shady surface of the A-shaped three-dimensional planting trellis and make the light reception more even. Furthermore, the light-receiving device may be shielded to avoid overt exposure to the crops when the illumination is too intense (e.g., when at noon). Also, the solar cell is used to generate electricity.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view illustrating a light guiding apparatus according to an embodiment of the disclosure.

FIG. 2 is a schematic view illustrating a single-axis or dual-axis rotating mechanism of a light guiding device in FIG. 1.

FIG. 3 is a schematic cross-sectional view illustrating a structure of a light guiding device according to an embodiment of the disclosure.

FIGS. 4A and 4B are schematic views illustrating a light guiding mechanism of a light guiding apparatus according to an embodiment of the disclosure.

FIGS. 5A and 5B are schematic views illustrating a relation between a width and a curvature radius of a light guiding device according to an embodiment of the disclosure.

FIG. 6 is a schematic view illustrating a light guiding mechanism of a light guiding apparatus according to an embodiment of the disclosure.

FIG. 7 is a schematic cross-sectional view illustrating a light guiding and electricity generating device according to an embodiment of the disclosure.

FIG. 8 is a schematic cross-sectional view illustrating an operational mode of a light guiding and electricity generating apparatus according to an embodiment of the disclosure.

FIG. 9 is a schematic cross-sectional view illustrating an operational mode of a light guiding and electricity generating apparatus according to an embodiment of the disclosure.

FIG. 10 is a schematic view illustrating a single-axis or dual-axis rotating mechanism of a light guiding and electricity generating device according to an embodiment of the disclosure.

FIG. 11 is a schematic cross-sectional view illustrating an operational mode of a light guiding and electricity generating apparatus according to an embodiment of the disclosure.

FIG. 12 is a schematic flowchart illustrating a light guiding and electricity generating method according to an embodiment of the disclosure.

### DETAILED DESCRIPTION OF DISCLOSED EMBODIMENTS

In multiple embodiments of the disclosure, an illumination efficiency of a light-receiving device can be improved, while electricity is also generated by using a solar cell at the same time.

For example, when used in a greenhouse, a light guiding and electricity generating apparatus may be set up. The light guiding apparatus may directly guide a solar light source to a shady surface of a three-dimensional trellis (for example, A-shaped three-dimensional trellis). Here, the A-shaped three-dimensional trellis is a type of light-receiving device, and is referred to in the following as light-receiving device. In the embodiments of the disclosure, the illumination of sunlight is increased by making adjustment in accordance with an angle of movement of sunlight illumination, power consumption of supplemental lighting using an artificial light source is reduced, and an unevenness in light shielding and light reception of the trellis is dealt with. Also, an electricity generating apparatus is used to generate electricity, so as to supplement with light and generate electricity.

Several embodiments are provided in the following for further descriptions. However, the disclosure is not limited to the embodiments described herein, and it may have suitable combination between embodiments.

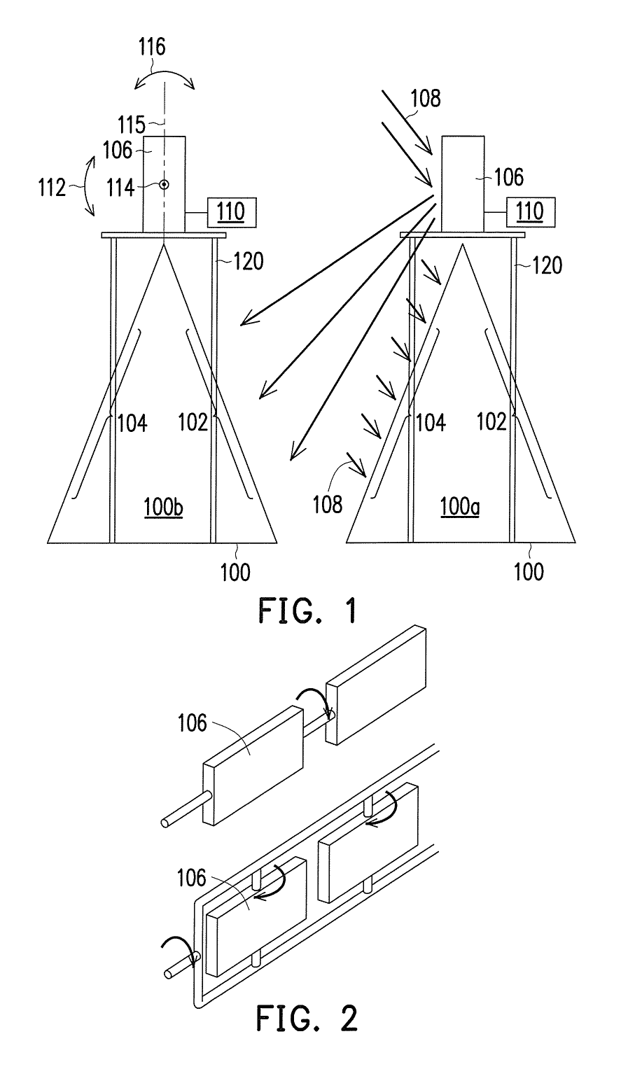

FIG. 1 is a schematic view illustrating a light guiding apparatus according to an embodiment of the disclosure. Referring to FIG. 1, the light guiding apparatus according to the embodiment of the disclosure includes a plurality of light-receiving devices 100, such as A-shaped devices, arranged in parallel. Each of the light-receiving devices 100 has an illuminated surface 104 and a shady surface 102 according to a position of incident light 108. The incident light 108 is sunlight, for example, and a position of the incident light 108 changes through time, making the illuminated surface 104 and the shady surface 102 variable. For example, in the morning, one side of the light-receiving device 100 is illuminated by the incident light 108 and is thus the illuminated surface 104, whereas in the afternoon, the same side is not illuminated by the incident light 108 and thus becomes the shady surface 102. For the ease of description, two adjacent light-receiving devices 100 may be referred to as a first light-receiving device 100a and a second light-receiving device 100b. At least one holding member 120 is disposed over the corresponding light-receiving device 100. As shown in FIG. 1, each of the first light-receiving device 100a and the second light-receiving device 100b is provided with the holding member 120. Taking the first light-receiving device 100a as an example, at least one light guiding device 106 is disposed on the holding member 120 and located above the first light-receiving device 100a. In addition, the light guiding device 106 includes a curved reflection surface facing toward second light-receiving device 100b and the dual-axis rotating mechanisms 112 and 116. The rotating mechanism 112 is related to pitching angle, and mainly serves to adjust an angle according to the movement of the sun from east to west during the daytime, and the rotating mechanism 116 is related to azimuth angle, and mainly serves to adjust the angle based on the movement of sun between the tropics every year. The light guiding device 106 may also have only the single-axis rotating mechanism 112 that corresponds to the angle of the movement of the sun during the daytime. At least one light guiding device 106 is provided. The embodiment is described to have one light guiding device 106 as an example. However, in practice, a plurality of the light guiding devices 106 may be disposed to cope with a plurality of light-receiving areas, and the light guiding devices 106 may form an array, for example.

FIG. 2 is a schematic view illustrating a single-axis or dual-axis rotating mechanism of a light guiding device in FIG. 1. Referring to FIG. 2, regarding the embodiments of configurations of the rotating mechanism, the upper part of FIG. 2 illustrates a single-axis rotation control that exerts control mainly in correspondence with an elevation angle of the sun. The lower part of FIG. 2 illustrates a dual-axis rotation control capable of making adjustment to the change of the path of the sun within a day in different seasons, so as to further increase the light-receiving efficiency.

By using the rotating mechanisms 112 and 116, the incident light 108 is reflected and directed to the shady surface 102 of the second light-receiving device 100b. A driving control apparatus 110 serves to control the rotating mechanism to rotate the light guiding device 106 and consequently guide the light. In addition, the driving control apparatus 110 is an electric motor, an electric actuator, or a hydraulic/air cylinder, etc., for example.

In an embodiment, the rotating mechanism 112 rotates in correspondence with an axial direction of a rotating axis 114. However, to more effectively track the change of the position of the sun through time within a day and within a year, multi-axial rotation may be employed. For example, the rotating mechanism 116 that rotates corresponding to another axial direction of a rotating axis 115 may be added. The rotating axis 114 and the rotating axis 115 may be perpendicular to each other (such as X-axis and Y-axis). Rotation of the rotating mechanisms 112 and 116 may be controlled by using the driving control apparatus 110. In this way, the light guiding device 106 may be effectively adjusted according to the change of the position of the sun through time, and a heliometer may be used together for tracking the sun. The detailed structure will be further described in the following embodiments.

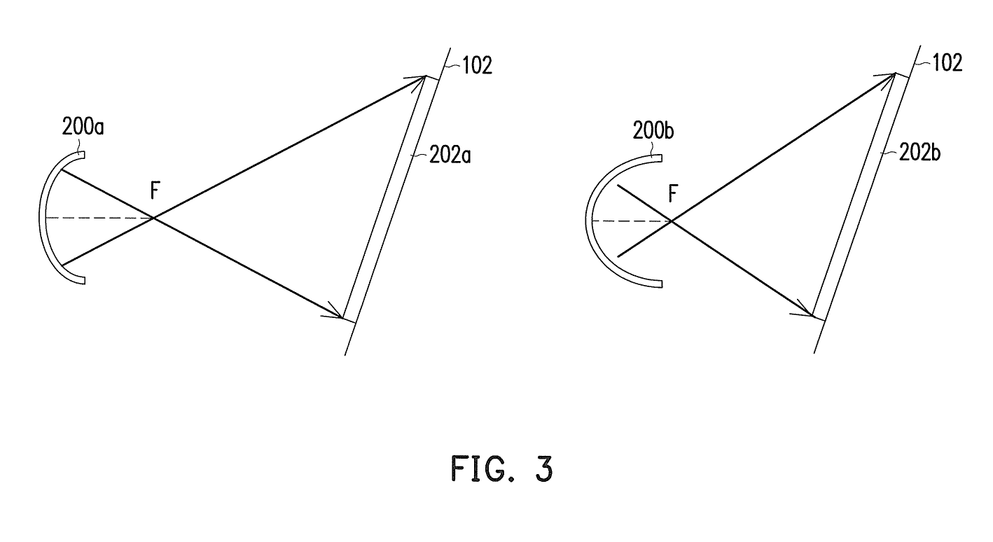

FIG. 3 is a schematic cross-sectional view illustrating a structure of a light guiding device according to an embodiment of the disclosure. Referring to FIG. 3, the light guiding device 106 includes curved light guiding devices 200a and 200b. The curved light guiding devices 200a and 200b are cylindrical curved surfaces, for example, such as sheet-like and inwardly curved metal plates. The curved surface has a focal point (F). After passing the focal point (F), light reflected by the light guiding devices 200a and 200b with curved surfaces form illuminated surfaces 202a and 202b having a uniform brightness within a certain range. The size of the illuminated surfaces 202a and 202b are determined by an actual distance and a focal distance. The longer the distances between the light guiding devices 200a and 200b and the illuminated surfaces 202a and 202b, the greater the size of diffusion areas becomes. In a scenario of a cylindrical surface, the focal distance corresponds to a cylindrical surface as an example, and the focal distance is a curvature radius. These changes allow designing of a shape of a reflection surface based on optical properties. Accordingly, when the light guiding devices 200a and 200b are used in the light guiding device 106 of FIG. 1, an illuminated surface having a large area may be generated for the light-receiving device 100, and the brightness may be more even. In a practical application of this embodiment, curvatures of the light guiding devices 200a and 200b is within a range that a radius (R) is 500 mm, 1000 mm, or from 500 mm to 1000 mm.

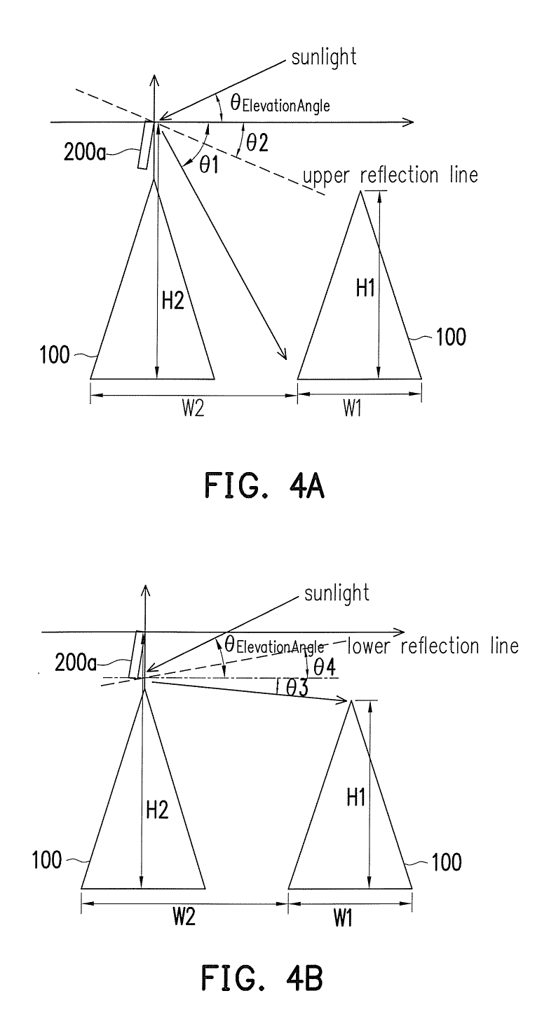

FIGS. 4A and 4B are schematic views illustrating a light guiding mechanism of a light guiding apparatus according to an embodiment of the disclosure. Referring to FIG. 4A, when the light guiding device 200a with a curved surface is used in the light guiding device 106 of FIG. 1, there are angle parameters based on geometrical optics. Referring to FIG. 4A, a height of the light-receiving device 100 is H1, a width thereof is W1, a distance between the two light-receiving devices 100 is W2, and the light guiding device 200a is disposed at a height H2, and has a width L. An included angle between reflected light at an upper edge of the light guiding device 200a and a horizontal surface is θ₁. An upper reflection line (a normal of the curved surface) is between incident sunlight and the reflected light, and an included angle between the upper reflection line and the horizontal surface is θ₂, and an included angle between the incident sunlight and the horizontal surface is an elevation angle θ_{ElevationAngle}. Relations between relevant parameters and the included angles θ₁ and θ₂ are represented in Formula (1) and Formula (2).

$$\begin{matrix}{θ}_{1} = {tan}^{- 1} \frac{- {H}_{2}}{{W}_{2} - 0.5 \times {W}_{1}} & ( 1 ) \\ {θ}_{2} = \frac{1}{2} ( {θ}_{ElevationAngle} + {θ}_{1} ) & ( 2 )\end{matrix}$$

Referring to FIG. 4B, an included angle between the reflected light at a lower edge of the light guiding device 200a and the horizontal surface is θ₃, and a lower reflection line (a normal of the curved surface) is between the incident sunlight and the reflected light, and an included angle between the lower reflection line and the horizontal surface is θ₄. Relations between relevant parameters and the included angles θ₃ and θ₄ are represented in Formula (3) and Formula (4).

$$\begin{matrix}{θ}_{3} = {tan}^{- 1} \frac{- {H}_{2} + {H}_{1} + L}{{W}_{2}} & ( 3 ) \\ {θ}_{4} = \frac{1}{2} ( {θ}_{ElevationAngle} + {θ}_{3} ) & ( 4 )\end{matrix}$$

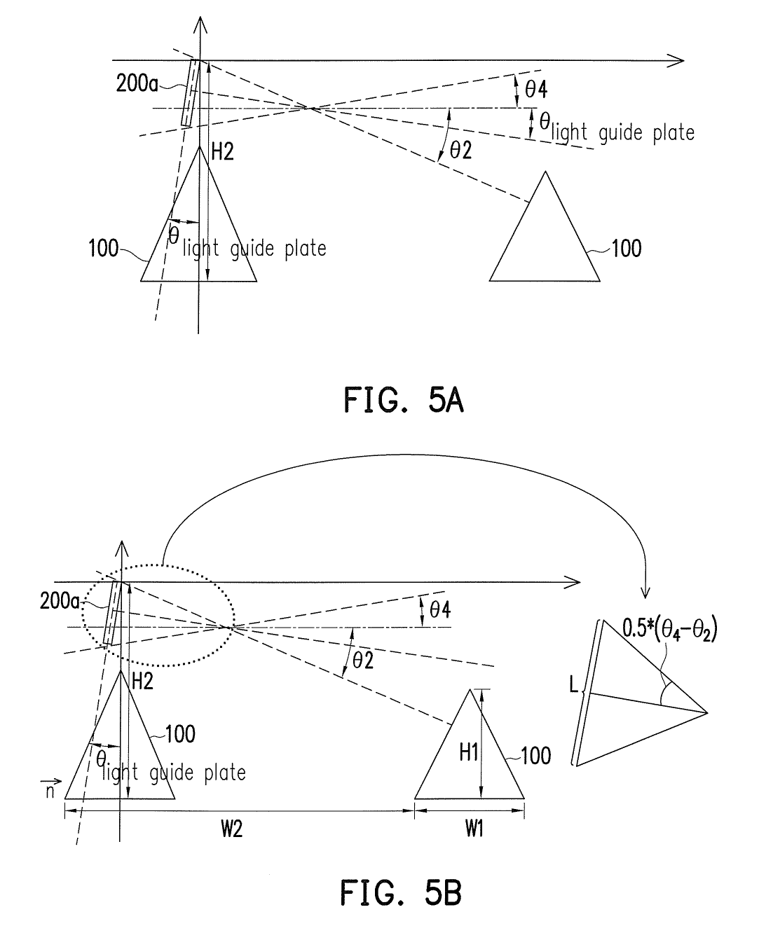

FIG. 5A is a schematic view illustrating a relation between a width and a curvature radius of a light guiding device according to an embodiment of the disclosure. Referring to FIG. 5A, the light guiding device 200a is illustrated as a light guiding plate. An included angle between the light guiding device 200a and a vertical surface is θ_{LightGuidePlate}. The included angles between the upper and lower reflection lines of the edges of the light guiding device 200a with a curved surface that pass through the focal point and a horizontal surface passing through the focal point are θ₄ and θ₂, respectively. Taking the angle parameters, along with spatial geometric positions of the light guiding device 200a with a curved surface and the light-receiving device 100, into consideration, the θ_{LightGuidePlate} (pitching angle) of the light guiding device 200a may be inferred. A vector of a line connects a crossing point of the upper and lower reflection lines of the light guiding device 200a and a central point of the light guiding device 200a. The rotating angle θ_{LightGuidePlate} is an included angle between the vector of the line and a horizontal line, and represents the rotating angle of the light guiding device. θ_{LightGuidePlate} may be represented in Formula (5).

θ_{LightGuidePlate}=½(θ₄+θ₂). (5)

FIG. 5B is a schematic view illustrating a relation between a width and a curvature radius of the light guiding device 200a according to an embodiment of the disclosure. Referring to FIG. 5B, taking a curved surface or a cylindrical surface as an example, as shown in the dotted line, an isosceles triangle may be formed from the focal point of the upper and lower reflection lines of the light guiding device 200a to two ends of the light guiding device 200a. With reference to the trigonometric functions, a relation between the width L and a curvature radius R of the light guiding device 200a is represented as Formula (6):

$$R = \frac{L / 2}{sin ( \frac{1}{2} ( {θ}_{4} - {θ}_{2} ) )} . \qquad ( 6 )$$

The angles, such as θ₄ and θ₂, are signed. Based on the conventional definition, a horizontal surface is 0 degrees, a counter-clockwise rotating angle is positive, and a clockwise rotating angle is negative.

In the calculation of FIGS. 4A to 4B and FIGS. 5A to 5B, the angle parameters and the geometric parameters, such as the size and the position of the light guiding device, are related. Taking rotation in an axial direction as an example, parameters such as the elevation angle θ_{ElevationAngle} of the sun, the height H1 of the light-receiving device 100, the width W1 of the light-receiving device 100, the height H2 where the light guiding device 200a is set, the distance W2 between the two light receive devices 100, and the width of the light guiding device 200a, etc., are required. For example, assuming that the height H1 of the light-receiving device 100 is 1550 mm, the width W1 thereof is 1334 mm, the distance W2 between the two light-receiving devices 100 is 2100 mm, the light guiding device 200a is disposed at the height H2 of 1850 mm, and the width L of the light guiding device is 240 mm, values relating to the angles θ_{ElevationAngle} and θ_{LightGuidePlate} and the curvature radius (R) of the light guiding device as shown in Table 1 can be obtained by substituting these values into Formulae (1) to (6).

TABLE 1
Table of Angles and Curvature of Light Guiding Device

| θ_{ElevationAngle} | θ_{LightGuidePlate} | Curvature |
|---|---|---|
| (degrees) | (degrees) | Radius (R) (mm) |
| 10 | −8.49 | 547 |
| 20 | −3.49 | 547 |
| 30 | 1.51 | 547 |
| 40 | 6.51 | 547 |
| 50 | 11.51 | 547 |
| 60 | 16.51 | 547 |
| 70 | 21.51 | 547 |
| 80 | 26.51 | 547 |

Therefore, it can be known from above, when the light guiding device 200 corresponds to the size of the light-receiving device 100, the radius curvature (R) is 547 mm. If the size of the area of the illuminated surface is to be adjusted, the curvature radius (R) may be adjusted within a range from 500 mm to 1000 mm, as shown in FIG. 3.

The parameters may be set based on actual calculation using geometric properties. Accordingly, the size and position that the light guiding device requires may be determined. However, such manner of setting is merely an example of embodiment, and shall not be construed as the only way to determine the size and position. For example, the relations may be determined based on actual measurements in experiments. Furthermore, a database may be set up for future references. Actually, with the conditions of the curvature radius and the width of the light guiding device, a light guiding direction as desired may be obtained by suitably adjusting a central normal direction of the light guiding device.

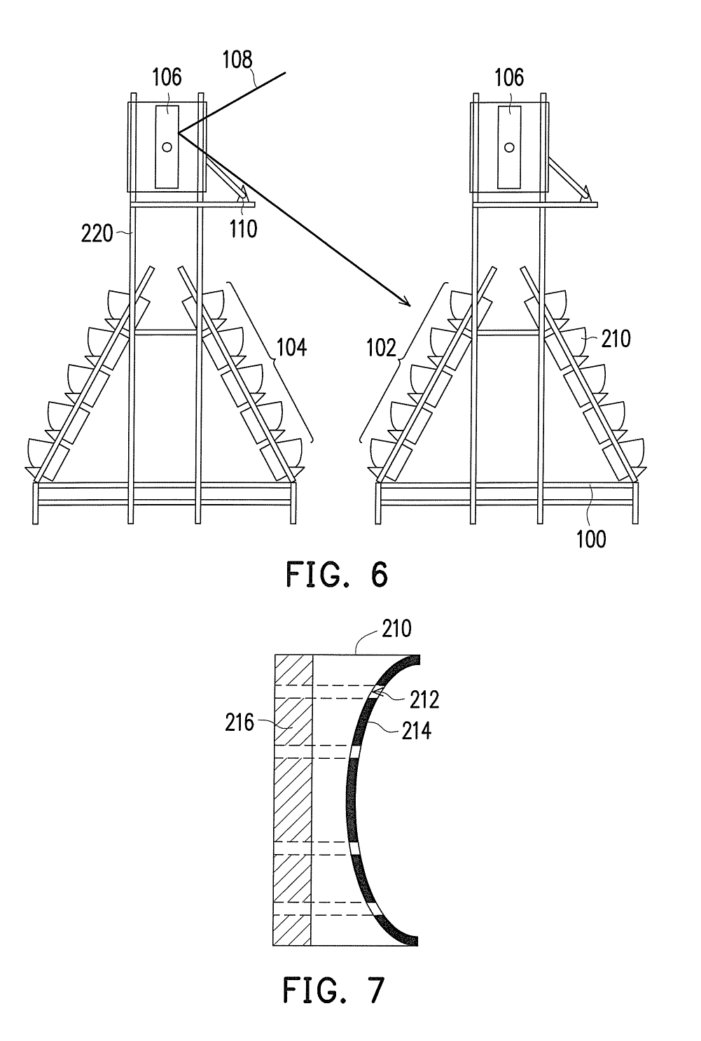

FIG. 6 is a schematic view illustrating a light guiding mechanism of a light guiding apparatus according to an embodiment of the disclosure. Referring to FIG. 6, the light guiding device of FIG. 2 is applied to an A-shaped three-dimensional planting structure. A plurality of planting cups is disposed on the illuminated surface 104 and the shady surface 102 of the light-receiving device 100. The holding member 220 holds the light guiding device 106. The driving control apparatus 110 may control the rotation of the light guiding device 106. In this way, the incident light 108 may be directed by the light guiding device 106 to the shady surface 102 of the adjacent light-receiving device 100, and the illuminated surface 104 remains to be illuminated with the incident light. Accordingly, when the illuminated surface 104 directly receives the light, the shady surface 102 may also receive the light indirectly at the same time, thereby making a better use of sunlight.

FIG. 7 is a schematic cross-sectional view illustrating a light guiding and electricity generating device according to an embodiment of the disclosure. Referring FIG. 7, in an alternative design of the light guiding device 106, the light guiding device 106 includes a light guiding and electricity generating device 210, for example. In addition to a light guiding device 214 having a structure of the light guiding device 200a with a curved surface, a solar cell 216 is further disposed on a back surface of the light guiding device 214. In addition, the light guiding and electricity generating device 210 is further provided with a ventilation opening 212 to reduce the wind resistance. It should be noted that the light guiding device 106 may also be provided with a ventilation opening similar to the ventilation opening 212. In other words, the ventilation opening in the light guiding device 214 and the ventilation opening in the solar cell 216 are disposed in correspondence with each other to reduce the wind resistance. Also, the ventilation opening 212 also permits passage of sunlight to provide a certain amount of light illumination.

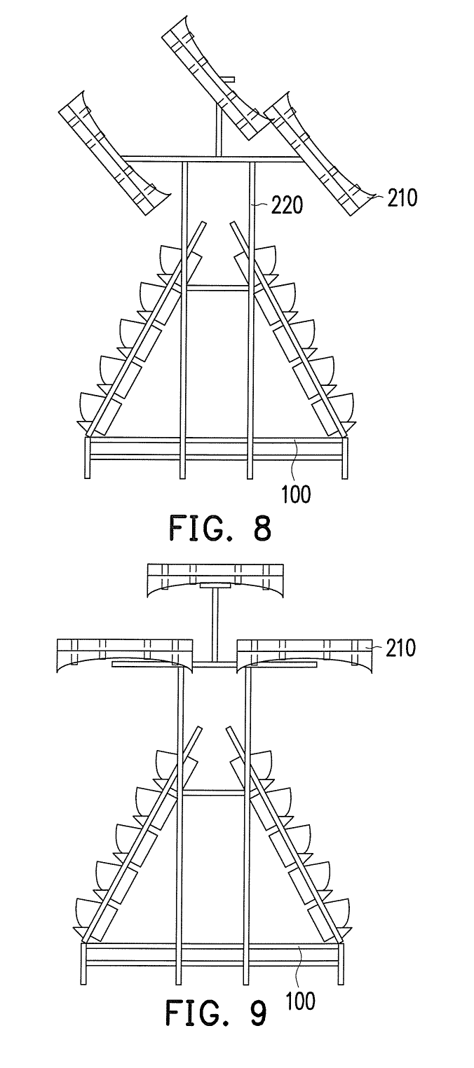

FIG. 8 is a schematic cross-sectional view illustrating an operational mode of a light guiding and electricity generating apparatus according to an embodiment of the disclosure. Referring to FIG. 8, the application of the light guiding and electricity generating device 210 in the light-receiving device 100 has a similar light guiding function as the description in FIGS. 2 and 6. In this embodiment, the number of the light guiding and electricity generating devices 210 is three, for example, and the light guiding and electricity generating devices 220 are held by the holding member 220. The light guiding and electricity generating devices 210 or the light guiding device 106 are controlled by the driving control apparatus to be rotated separately or jointly. When the light guiding and electricity generating apparatus needs to guide the light toward the light-receiving device 100 (not shown) at the right side of the drawing, the light guiding and electricity generating devices (in the middle and at the right) 210 at the right side of the drawings are operated, so as to supplement the shady surface of the adjacent light-receiving device 100 (not shown in the drawing) with light. Alternatively, when the light guiding and electricity generating device needs to guide the light toward the light-receiving device (not shown in the drawing) at the left side of the drawing, the light guiding and electricity generating devices 210 (in the middle and at the left) at the left side of the drawings are operated, so as to supplement the shady surface of the adjacent light-receiving device 100 (not shown in the drawing) with light.

In an operation, when illumination to the shady surface of the light-receiving device 100 is required, the curved reflection surface may offer indirect illumination to the shady surface as described above.

FIG. 9 is a schematic cross-sectional view illustrating an operational mode of a light guiding and electricity generating apparatus according to an embodiment of the disclosure. FIG. 9 illustrates another operational mode. For example, over-illumination may occur when the sunlight directly illuminates crops at noon. Thus, the driving control apparatus may be used to control the rotating mechanism, such that the solar cell 216 of the light guiding and electricity generating device 210 is rotated upward to receive the incident light as well as shield the light-receiving device 100. At this time, the ventilation opening 212 still provides the light-receiving device 212 with a certain amount of illumination. The size, number, density, and shape of the ventilation opening 212 may be determined based on practical needs.

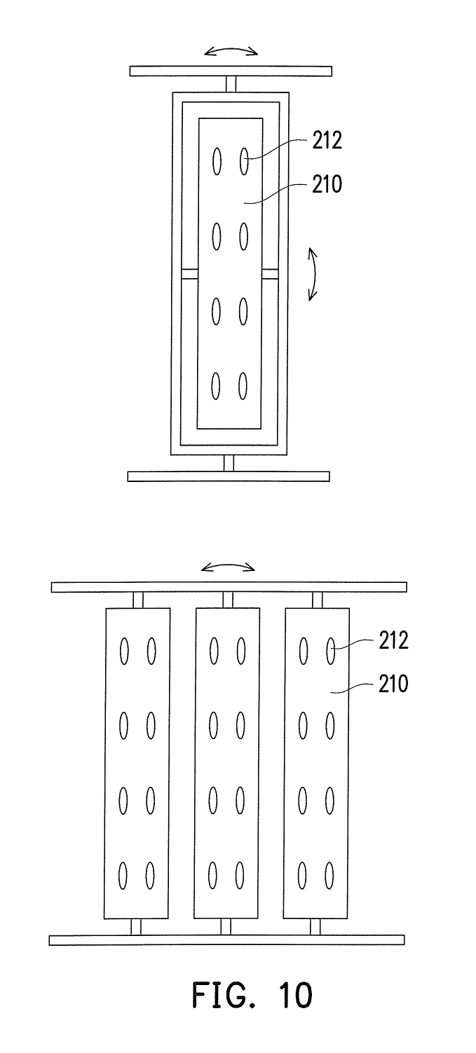

FIG. 10 is a schematic view illustrating a single-axis or dual-axis rotating mechanism of the light guiding and electricity generating device 210 according to an embodiment of the disclosure. Referring to FIG. 10, from a perspective facing the curved surface of the light guiding and electricity generating device 210, a plurality of the ventilation openings 212 are provided on the light guiding and electricity generating device 210. The upper part of the drawing illustrates a dual-axis rotating control mechanism that allows rotation in two directions. The lower part of the drawing illustrates a single-axis rotating control mechanism that allows rotation in only one direction. A degree of axial rotation of the light guiding and electricity generating device 210 is deter mined based on practical needs and cost consideration.

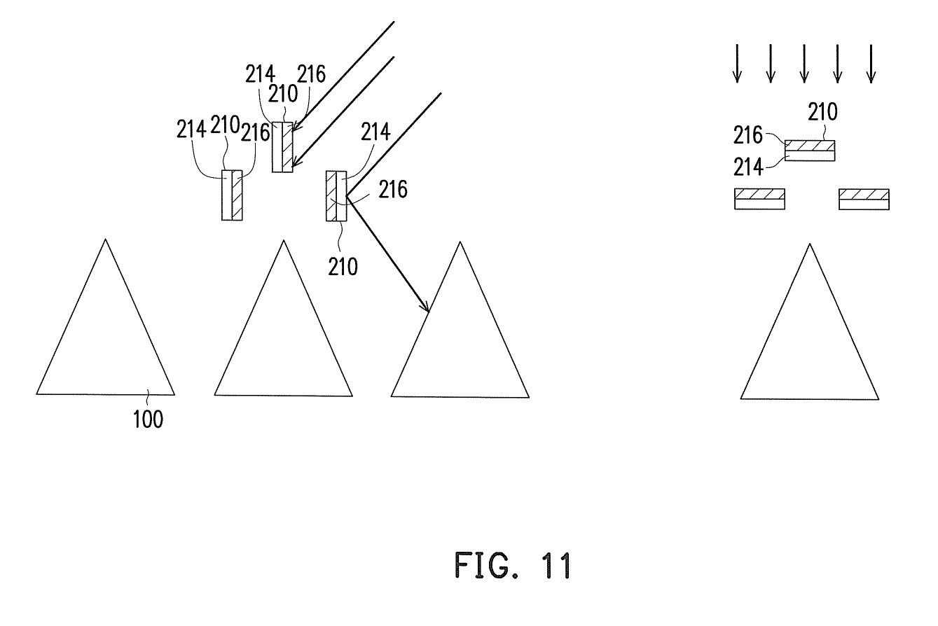

FIG. 11 is a schematic cross-sectional view illustrating an operational mode of a light guiding and electricity generating apparatus according to an embodiment of the disclosure. Referring to FIG. 11, a method for controlling the light guiding and electricity generating devices 210 is described in the following with an additional embodiment. Rotations of the light guiding and electricity generating devices 210 of this embodiment may be separately controlled. In a control mode shown in the left of FIG. 11, only one of the light guiding and electricity generating devices 210 is rotated, for example, to provide supplemental lighting and illumination to the shady surface of the adjacent light-receiving device 100. Rest of the light guiding and electricity generating devices 210 may be rotated to allow the solar cells 216 to receive the incident light and thus generate electricity. In another control mode shown in FIG. 10, when the light-receiving device 100 needs to be shielded at noon, for example, all of the light guiding and electricity generating devices 210, for example, may be rotated to make the solar cells 216 facing toward the sunlight.

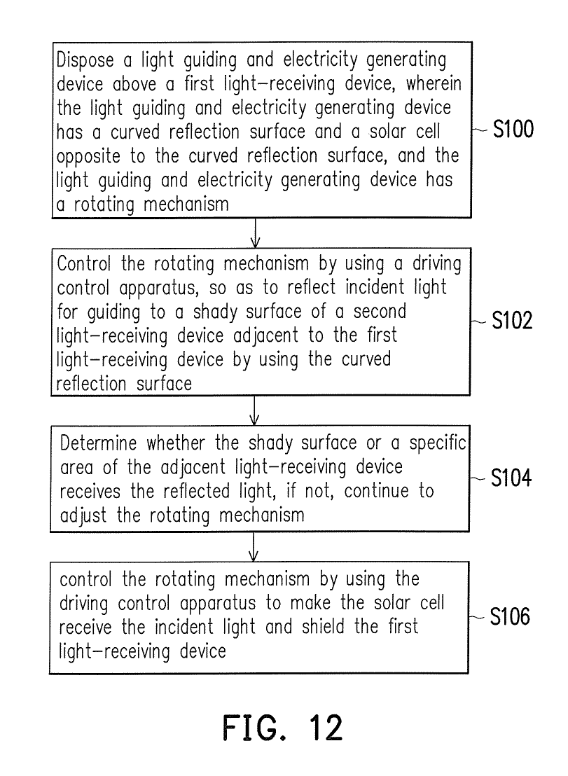

FIG. 12 is a schematic flowchart illustrating a light guiding and electricity generating method according to an embodiment of the disclosure. Referring to FIG. 12, in terms of an operational effect, the light guiding and electricity generating method includes Steps S100, S102, S104, and S106. At Step S100, a light guiding and electricity generating apparatus is disposed above a light-receiving device, for example. The light guiding and electricity generating apparatus includes a light guiding and electricity generating device having a curved reflection surface and a solar cell opposite to the curved reflection surface. In addition, the light guiding and electricity generating apparatus has a rotating mechanism. At Step S102, a driving control apparatus is used to control the rotating mechanism, such that the curved reflection surface directs incident light to a shady surface of an adjacent light-receiving device or a specific area of the adjacent light-receiving device. At Step S104, whether the shady surface or the specific area of the adjacent light-receiving device receives the reflected light is determined. If not, the rotating mechanism is further adjusted. At Step S106, based on an intensity of illumination, the driving control apparatus is used to control the rotating mechanism to allow the solar cell to receive the incident light. If the intensity of illumination exceeds a predetermined value, the light guiding and electricity generating device is rotated to allow the solar cell to receive the light, generate electricity, and shield the light-receiving device.

In an embodiment of the light guiding and electricity generating method, the light guiding and electricity generating device is further provided with a ventilation opening to reduce wind resistance. When the light guiding device shields the light-receiving device, the solar cell receives the incident light and the ventilation opening still provides the light-receiving device with an amount of illumination.

In an embodiment of the light guiding and electricity generating method, the rotating mechanism is rotated in an axial direction, in dual axial directions, or multiple axial directions.

In an embodiment of the light guiding and electricity generating method, the curved reflection surface is a metal reflection surface, such as a stainless steel plate or a highly reflective mirror-surface steel plate.

In an embodiment of the light guiding and electricity generating method, a plurality of the light guiding and electricity generating devices are provided, and the light guiding and electricity generating devices are controlled by the driving control apparatus to be rotated separately or jointly.

In view of the foregoing, the rotation control in one or more axial directions is provided in the embodiments of the disclosure to guide the sunlight to the shady surface of the light-receiving device 100. In addition, the solar cell is disposed on another surface of the light guiding and electricity generating device. When the light guiding and electricity generating device does not need to provide supplemental lighting to the shady surface, the light guiding and electricity generating device may be rotated to make the solar cell generate electricity.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A light guiding apparatus, comprising:
at least two adjacent light-receiving devices, comprising a first light-receiving device and a second light-receiving device, wherein each of the light-receiving devices has an illuminated surface and a shady surface according to a position of incident light;
a holding member, disposed over the corresponding first light-receiving device;
a light guiding device, disposed on the holding member and located above the first light-receiving device, wherein the light guiding device has a curved reflection surface and a rotating mechanism and reflects the incident light for guiding toward the shady surface of the adjacent second light-receiving device or shields the first light-receiving device by using the rotating mechanism; and
a driving control apparatus, controlling the rotating mechanism to rotate the light guiding device.

2. The light guiding apparatus as claimed in claim 1, wherein the rotating mechanism is rotated in an axial direction or in multiple axial directions.

3. The light guiding apparatus as claimed in claim 1, wherein the light guiding apparatus is provided with a ventilation opening to reduce wind resistance, and when the light guiding device shields the first light-receiving device, the ventilation opening still provides the first light-receiving device with illumination.

4. The light guiding apparatus as claimed in claim 1, wherein the light guiding device further comprises a solar cell disposed on a surface of the light guiding device opposite to the curved reflection surface.

5. The light guiding apparatus as claimed in claim 4, wherein the light guiding apparatus is provided with a ventilation opening to reduce wind resistance, and when the light guiding device shields the first light-receiving device, the ventilation opening still provides the first light-receiving device with illumination.

6. The light guiding apparatus as claimed in claim 4, wherein when the light guiding device is controlled by the driving control apparatus to shield the first light-receiving device, the solar cell receives the incident light.

7. The light guiding apparatus as claimed in claim 4, wherein the solar cell is further provided with a ventilation opening to reduce wind resistance, and when the solar cell shields the first light-receiving device, the solar cell receives the incident light and the ventilation opening provides the first light-receiving device with illumination.

8. The light guiding apparatus as claimed in claim 1, wherein the number of the light guiding device is plural, and the plurality of the light guiding devices are controlled by the driving control apparatus to be rotated separately or jointly.

9. The light guiding apparatus as claimed in claim 1, wherein the curved reflection surface of the light guiding device is a metal reflection surface.

10. The light guiding apparatus as claimed in claim 1, wherein the light-receiving devices is a three-dimensional trellis.

11. A light guiding and electricity generating method, comprising:
disposing a light guiding and electricity generating device above a first light-receiving device, wherein the light guiding and electricity generating device has a curved reflection surface and a solar cell opposite to the curved reflection surface, and the light guiding and electricity generating device has a rotating mechanism;
controlling the rotating mechanism by using a driving control apparatus, so as to reflect incident light for guiding to a shady surface of a second light-receiving device adjacent to the first light-receiving device by using the curved reflection surface; and
controlling the rotating mechanism by using the driving control apparatus to make the solar cell receive the incident light and shield the first light-receiving device.

12. The light guiding and electricity generating method as claimed in claim 11, wherein the light guiding and electricity generating device is further provided with a ventilation opening to reduce wind resistance, wherein when the light guiding device shields the first light-receiving device, the solar cell receives the incident light and the ventilation opening still provides the first light-receiving device with illumination.

13. The light guiding and electricity generating method as claimed in claim 11, wherein the rotating mechanism is rotated in an axial direction or in multiple axial directions.

14. The light guiding and electricity generating method as claimed in claim 13, wherein the light guiding and electricity generating device is further provided with a ventilation opening to reduce wind resistance, wherein when the light guiding device shields the first light-receiving device, the solar cell receives the incident light and the ventilation opening still provides the first light-receiving device with illumination.

15. The light guiding and electricity generating method as claimed in claim 13, wherein the curved reflection surface of the light guiding and electricity generating device is a metal reflection surface.

16. The light guiding and electricity generating method as claimed in claim 13, wherein the number of the light guiding and electricity generating device is plural, and the light guiding and electricity generating devices are separately or jointly rotated.
